(19) United States
(12) Patent Application Publication
(10) Pub. No.: US 2011/0010234 A1
(43) Pub. Date: Jan. 13, 2011

(54) MOBILE DEVICE INCLUDING AUTO INITIATION

(76) Inventors: Mike Lindelsee, Redwood City, CA (US); Erick Wong, Menlo Park, CA (US); David Wentker, San Francisco, CA (US); Olivier Brand, Walnut Creek, CA (US); Joseph J. Mirizzi, Copperopolis, CA (US); Derek Alan Vroom, San Mateo, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/817,103

(22) Filed: Jun. 16, 2010

Related U.S. Application Data
(60) Provisional application No. 61/223,561, filed on Jul. 7, 2009.

(51) Int. Cl. G06Q 30/00; G06Q 40/00

(52) U.S. Cl. 705/14.23; 705/14.36

(57) ABSTRACT

Systems and methods for redeeming coupons are provided. The method includes receiving a coupon at a mobile payment device, determining whether a mobile payment application is active. If the mobile payment application is not active, the mobile payment device may automatically initiate the mobile payment application and conduct the transaction using the received coupon. The method further includes enrolling the mobile payment device in a coupon redemption program prior to using the coupon. The method also includes tracking a consumer's transaction information and sending one or more coupons based on the transaction information. The mobile payment device used for conducting the transaction includes a contactless element that can use the near field communications technology to conduct payment transactions.

### CROSS-REFERENCES TO RELATED APPLICATIONS

The present application claims benefit under 35 U.S.C. §119(e) of U.S. Provisional Patent Application No. 61/223,561, entitled “Payment During Coupon Redemption”, filed Jul. 7, 2009, the contents of which is hereby incorporated by reference in its entirety for all purposes.

### BACKGROUND

Coupons have been in common use for decades. In a conventional system coupons were delivered by mail and were printed on paper. A consumer wishing to use the coupon would normally have to carry a physical coupon to a store in order to redeem the coupon. In recent years, coupons are being sent electronically via email and other means. However, even currently, a consumer has to present a physical copy of the received coupon to redeem it at a brick-and-mortar store.

With the advent of on-line stores, electronic coupons can now be used in their electronic form at these online stores and the need for carrying a physical coupon has greatly diminished. The electronic coupons or e-coupons may be in the form of a string of alphanumeric characters. The alphanumeric string may be presented to the online store during the purchase process in order to redeem the coupon. However, even today, if the consumer wishes to redeem a coupon at a brick-and-mortar store, he still has to present some physical manifestation of the coupon.

Further, even if a consumer receives an electronic coupon, the consumer needs to look at the coupon on his or her mobile device, and needs to specifically choose a payment application and launch it to make a payment and redeem the coupon. This can be awkward and cumbersome as the consumer needs to review and open multiple items on his phone to perform the simple act of redeeming a coupon and conducting a transaction.

Embodiments of the invention address these and other problems, individually and collectively.

### SUMMARY

Certain embodiments of the present invention provide methods for using electronic coupons. Specifically, some embodiments provide a method for using a coupon received at a mobile device. The coupon can be redeemed at any location that supports payments using near field communication technology by using the mobile device to conduct the transaction.

One embodiment of the present invention provides a method for using a coupon. The method includes receiving coupon data at a mobile device. The mobile device may include a mobile payment application that is resident on the mobile device. The method further includes determining, by the mobile device, if the mobile payment application is operational, automatically initiating the mobile payment application after the coupon data is received by the mobile device, and transferring the coupon data to a receiving terminal as part of a transaction.

Another embodiment of the present invention provides a method for redeeming a coupon using a mobile payment device. The method includes the coupon administering entity determining whether a consumer of the mobile payment application is authorized to use a particular coupon. If the coupon administering entity determines that the consumer is not authorized to use the coupon, the coupon administering entity may request the consumer to obtain authorization in order to use the coupon. The request may be presented to the consumer on the mobile payment device and the consumer may be given a choice to either request the authorization or continue the transaction without using the coupon. The consumer, via the mobile payment device, may respond to the request by sending an authorization request to the coupon administering entity. The coupon administering entity may provide the authorization that is subsequently received by the mobile payment device. Upon receipt of the authorization, the transaction may be completed using the coupon.

In yet another embodiment, a coupon distribution method to a mobile device is provided. The method includes receiving a request from a consumer mobile device for enrolling the consumer mobile device in a coupon redemption program, enrolling the consumer mobile device in the coupon redemption program, and sending coupon data to the consumer mobile device upon completion of enrollment.

According to some embodiments of the present invention, a mobile payment device is provided. The mobile payment device includes a mobile payment application configured to enable a consumer to perform transactions using the mobile payment device, a coupon management module configured to receive coupon data from a coupon administering entity, and a processor coupled to the mobile payment application and the coupon management module. The processor is configured to retrieve coupon data from the coupon management module, determine whether the mobile payment application is operational, automatically initiate the mobile payment application after retrieving the coupon data, and transfer the coupon data to a receiving terminal as part of a transaction.

The following detailed description, together with the accompanying drawings will provide a better understanding of the nature and advantages of the present invention.

### BRIEF DESCRIPTION OF THE DRAWINGS

FIG. 1 is a block diagram of a payment processing system according to an embodiment of the present invention.

FIG. 2 is a block diagram of a mobile payment device according to an embodiment of the present invention.

FIGS. 3A-3C is a series of schematic drawings of a mobile payment device displaying coupon information according to an embodiment of the present invention.

FIG. 4 is a flow chart of a process for redeeming a coupon according to an embodiment of the present invention.

FIG. 5 is a flow chart of a process for redeeming a coupon according to another embodiment of the present invention.

FIG. 6 is a flow chart of a process for redeeming a coupon according to yet another embodiment of the present invention.

FIG. 7 is a block diagram of a computer apparatus according to an embodiment of the present invention.

### DETAILED DESCRIPTION

Certain embodiments of the present invention provide system and methods for using a coupon for conducting a transaction. In some embodiments, a mobile payment device can receive a coupon from a coupon issuing or administering entity. The mobile payment device may have a mobile payment application installed on it in addition to other hardware, e.g., contactless payment hardware, to facilitate a payment transaction. If a consumer of the mobile device wishes to use the coupon, the mobile payment device can automatically launch the mobile payment application and redeem the coupon.

In some embodiments, the consumer may need to enroll his mobile payment device in a coupon redemption program prior to being able to use a coupon. In some embodiments, the consumer can enroll in the coupon redemption program concurrently with redeeming a coupon. In some embodiments, if the mobile payment application is disabled and the consumer wants to redeem a coupon, the mobile payment device may temporarily enable the mobile payment application, conduct the transaction using the coupon, and disable the mobile payment application after the transaction is completed.

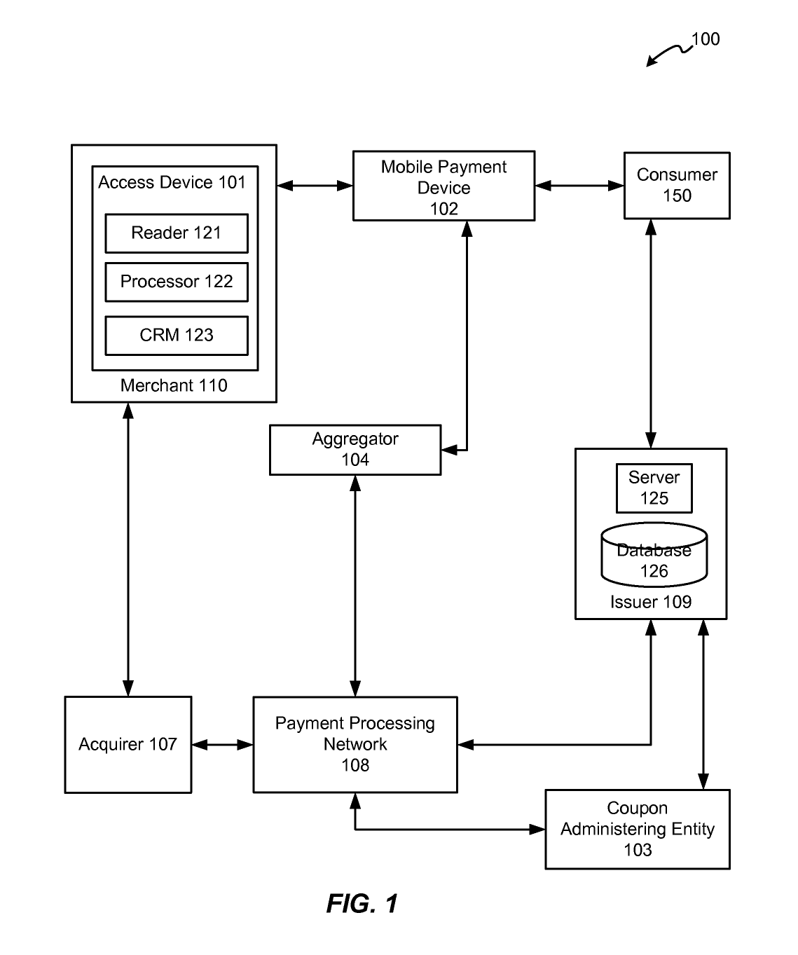

FIG. 1 illustrates a payment processing system 100 that can be used in an embodiment of the invention. For simplicity of discussion, one merchant, one issuer, one acquirer, one mobile payment device, and one consumer are shown. It is understood however, that embodiments of the invention may include multiple merchants, issuers, acquirers, mobile payment devices, and/or consumers. In addition, some embodiments of the invention may include fewer than all of the components shown in FIG. 1. Also, the components in FIG. 1 may communicate via any suitable communication medium (including the Internet), using any suitable communication protocol.

System 100 includes a merchant 110 and an acquirer 107 associated with merchant 110. In a typical payment transaction, a consumer 150 may purchase goods or services from the merchant 110 using a mobile payment device 102, such as a mobile phone. Mobile payment device 102 may be equipped with appropriate hardware and software to conduct the payment transaction. The payment transaction may occur at one or more transaction locations involving merchant 110, mobile payment device 102, and consumer 150. An acquirer 107 can communicate with an issuer 109 via a payment processing network 108. Either issuer 109 or payment processing network 108 can provide acquirer 107 and merchant 110 with a transaction authorization response in the form of an authorization response message. Payment processing network 108 can also communicate with mobile payment device 102 via an aggregator 104, which may provide coupon notifications.

Acquirer 107 is typically a bank where merchant 110 has an account. Issuer 109 may be an entity where the consumer of mobile payment device 102 has an account. Issuer 109 may also be a bank, but could also be a business entity such as a retail store. Some entities may function as both acquirers and issuers, and embodiments of the invention include such entities. Issuer 109 may operate a server computer 125, which may have a computer readable medium comprising code for performing the functions that issuer 109 performs. Database 126 comprising account number information and other information may be operatively coupled to server computer 125.

Consumer 150 may be an individual, or an organization such as a business that is capable of purchasing goods or services. In one embodiment, consumer 150 may be one or more individuals who are authorized to use mobile payment device 102.

Mobile payment device 102 may be any suitable portable device that is adapted to conduct payment transactions. Such mobile payment devices may include mobile phones, portable digital assistants (PDAs), or any other mobile device with the requisite functionality. Mobile payment device 102 may comprise a computer readable medium (not shown). The computer readable medium may be non-transitory memory, e.g., a hard drive, flash memory, CD ROM, etc. that stores data. Exemplary computer readable media may be in any suitable form including volatile or non-volatile memory.

Payment processing network 108 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

Payment processing network 108 may include a server computer (not explicitly shown). A “server computer” or “server” is typically a powerful computer or cluster of computers. For example, the server computer can be a large mainframe, a minicomputer cluster, or a group of servers functioning as a unit. In one example, the server computer may be a database server coupled to a Web server. Payment processing network 108 may use any suitable wired or wireless network, including the Internet.

Merchant 110 may also have, or may receive communications from, an access device 101 that can interact with mobile payment device 102. In FIG. 1, access device 101 is located at merchant 110. However, it could be located at any other suitable location in other embodiments of the invention.

Access device 101 can be in any suitable form such as, point of sale (POS) devices, cellular or mobile phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

In some embodiments, access device 101 may be a point of sale terminal. In such an instance, access device 101 may include a reader 121, a processor 122, and a computer readable medium (CRM) 123 all operatively coupled together. Reader 121 may include any suitable contact or contactless mode of operation. For example, exemplary card readers can include RF (radio frequency) antennas, magnetic stripe readers, etc. to interact mobile payment device 102.

In some embodiments, system 100 may include a coupon administering entity 103. Coupon administering entity 103 may be a separate entity or can be a part of issuer 109 or payment processing network 108. In some embodiments, coupon administering entity 103 may receive input from issuer 109 or payment processing network 108 about the transaction details of transactions performed by consumer 150. Coupon administering entity 103 can analyze this data and generate one or more coupons to be delivered to the consumer's mobile payment device 102. In some embodiments, coupon administering entity 103 may send the coupon to payment processing network 108, which may forward the coupon to mobile payment device 102. In some embodiments, payment processing network 108 may store one more coupons received from coupon administering entity 103 and forward an appropriate coupon to mobile payment device 102 based on the most recent transaction conducted using mobile payment device 102. For example, if mobile payment device 102 is used to conduct a transaction at a coffee shop A, payment processing network 108 may, as part of the payment processing cycle or at a later time, send a coupon that can be redeemed at the coffee shop A or a coupon for a competitor coffee shop B, to mobile payment device 102. The rules regarding the communication of coupons can be set by coupon administering entity 103 in consultation with the coupon issuer. Coupon administering entity 103 may be implemented using one or more server computers having the requisite functionality.

In some embodiments, one or more coupon issuers may register with coupon administering entity 103 to provide coupons to coupon administering entity 103. Coupon issuers may include entities that provide goods and services for consumers, and the like. Merchants (e.g., merchant 110), as well as issuers (e.g., issuer 109) may be examples of coupon issuers. In some embodiments, coupon issuers may authorize third parties to issue coupons on their behalf. Coupon issuers, or their authorized representatives, may provide coupon administering entity 103 with criteria to be used for issuing coupons to consumers. For example, the coupon issuer may instruct coupon administering entity 103 to issue a coupon if the transaction amount exceeds a threshold value. The threshold value may be the total transaction amount, e.g., $100, or number of items purchased, e.g., buy 2 get 1 free, or any other criteria that the coupon issuer may decide. In some embodiments, the coupon issuer may not provide any criteria and merely send out coupons according to a predetermined schedule. In an embodiment, the coupon issuer may also act as coupon administering entity 103.

In some embodiments, coupon administering entity 103 may include various subsystems which are capable of receiving enrollment data from one or more consumers via one or more mobile payment devices and enroll the one or more consumers, such as consumer 150, into a program for receiving coupons. Such a program may be referred to as a coupon redemption program. Coupon administering entity 103 may be communicatively coupled to issuer 109, payment processing network 108, and mobile payment device 102 in order to implement and manage the coupon redemption program.

Aggregator 104 may collect coupons from issuer 109, coupon administering entity 103, merchant 110, or payment processing network 108, and may thereafter send them to mobile payment device 102. Aggregator 104 may be an entity or organization that receives and transmits messages to a phone, email account, etc. In some cases, wireless telephone companies or the systems associated therewith may be considered aggregators.

Coupons may be in any suitable form and may be delivered by any suitable method. For example, a coupon may be delivered to mobile payment device 102 using a short message service (SMS) message, e.g., a text message, an instant messaging (IM) message, an email message, or any other electronic messaging means. In some embodiments, coupons may be sent immediately after a certain transaction is performed. In other embodiments, consumer 150 may subscribe to get the coupons periodically, e.g., weekly or monthly.

In a typical purchase transaction, consumer 150 may purchase a good or service at merchant 110 using mobile payment device 102. Mobile payment device 102 can interact with access device 101 located at merchant 110. For example, consumer 150 may make connect his mobile payment device to the POS terminal using an appropriate slot in the POS terminal. Alternatively, the POS terminal may be a contactless reader, and mobile payment device 102 may be a contactless device, e.g., a contactless card or may be a portable device that incorporates a contactless device, e.g., a cellular phone or a PDA.

An authorization request message may be forwarded to acquirer 107. After receiving the authorization request message, the authorization request message may be sent to payment processing network 108. Payment processing network 108 may forward the authorization request message to issuer 109.

After issuer 109 receives the authorization request message, issuer 109 may send an authorization response message back to payment processing network 108 to indicate whether or not the current transaction is authorized. Payment processing network 108 may forward the authorization response message back to acquirer 107. Acquirer 107 may send the authorization response message back to merchant 110.

After merchant 110 receives the authorization response message, access device 101 at merchant 110 may then provide the authorization response message to consumer 150. The authorization response message may be displayed by access device 101 or mobile payment device 102, or may be printed out on a receipt.

At the end of the day, a normal clearing and settlement process can be conducted by payment processing network 108. A clearing process is a process of exchanging financial details between an acquirer and an issuer to facilitate posting to a consumer's account and reconciliation of the consumer's settlement position.

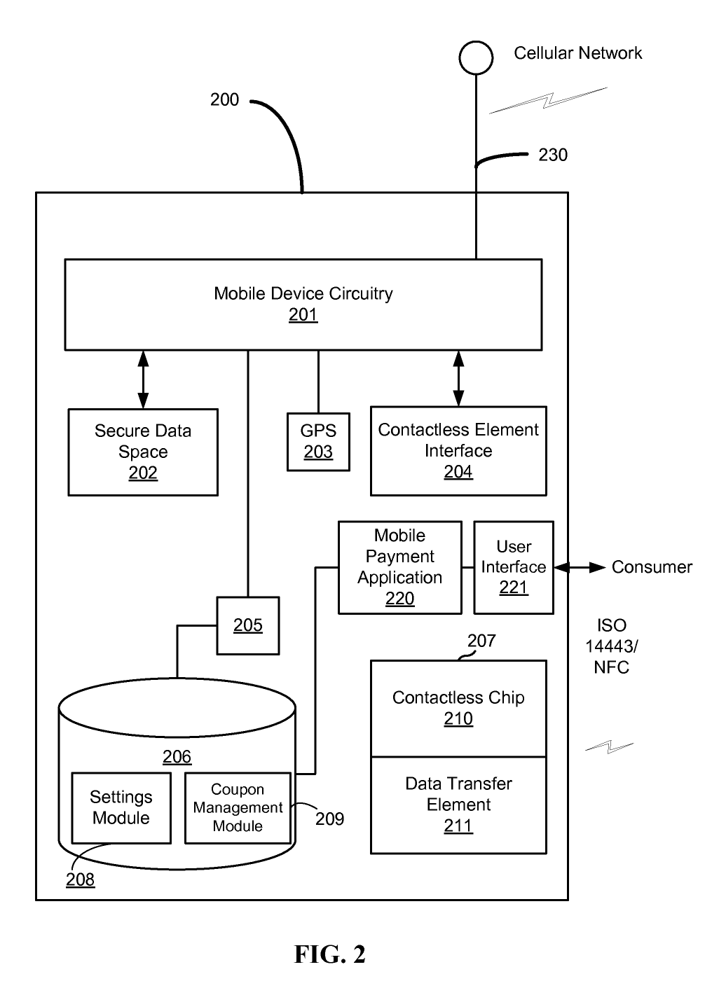

FIG. 2 is a block diagram of an exemplary mobile payment device 200. In an embodiment mobile payment device 200 may be a cellular phone. In other embodiments, mobile payment device 200 may be a personal digital assistant (PDA) or any mobile communications device capable of sending and receiving electronic communications.

Mobile payment device 200 may include a mobile payment application 220 configured to enable a consumer to perform transactions using mobile payment device 200, and a coupon management module 209 configured to receive coupon data from a coupon administering entity. It may also include a processor 205 coupled to mobile payment application 220 and coupon management module 209, where processor 205 is configured to retrieve coupon data from coupon management module 209, determine whether mobile payment application 220 is operational, automatically initiate mobile payment application 220 after retrieving the coupon data, and transfer the coupon data to a receiving terminal as part of a transaction. Mobile payment device 200 may also include a computer readable medium comprising code, executable by the processor, for retrieving coupon data from the coupon management module, determining whether the mobile payment application is operational, automatically initiating the mobile payment application after retrieving the coupon data, and transferring the coupon data to a receiving terminal as part of a transaction

Mobile payment device 200 may include a contactless element 207, typically implemented in the form of a semiconductor chip 210 (or other data storage element) with an associated wireless data transfer (e.g., data transmission) element 211, such as an antenna. Contactless element 207 is associated with (e.g., embedded within) mobile payment device 200 and data such as a coupon or control instructions transmitted via cellular network may be applied to contactless element 207 by means of contactless element interface 204. Contactless element interface 204 functions to permit the exchange of data and/or control instructions between a mobile device circuitry 201 (and hence the cellular network) and contactless element 207.

Contactless element 207 may be capable of transferring and receiving data using a near field communications capability (or near field communications medium) typically in accordance with a standardized protocol or data transfer mechanism (identified as ISO 14443/NFC in the figure). Near field communications capability is a short-range communications capability, such as RFID, Bluetooth™, infra-red, or other data transfer capability that can be used to exchange data between mobile payment device 200 and a local apparatus, for example a point-of-sale device of a merchant or another location at which coupons are expected to be redeemed. Thus, mobile payment device 200 may be capable of communicating and transferring data and/or control instructions via both cellular network and near field communications medium.

Mobile payment device 200 may also include a secure data space 202, which may be used by mobile payment device 200 to store operating parameters and/or other data utilized in its operation. Secure data space 202 may be in the form of a chip that is separate and apart from the chip in contactless element 207, or alternatively, could be a section of memory in the chip that forms part of contactless element 207. Note that the chip in contactless element 207 may include data storage capability in the form of a memory that may be accessed via interface 204 to permit the implementation of read, write, and erase functions.

In accordance with some embodiments, mobile payment device 200 may further include a processor 205 and a computer readable storage medium 206 for storing code and configured to direct the processor to perform various tasks. For example, computer readable storage medium 206 may comprise non-transitory memory device such as, a magnetic disk drive or a flash memory chip.

As discussed below, computer readable storage medium 206 may contain code that is configured to cause a processor of mobile payment device 200 to receive and recognize a message including a coupon and code that is delivered to mobile payment device 200. Computer readable storage medium 206 may also include code that is configured to decrypt an encrypted message.

In addition, computer readable storage medium 206 may store various functional modules. It may include a settings module 208 that can be use to configure various operations of mobile payment device 200, and it may also include a coupon management module 209. Coupon management module 209 may receive the one or more coupons sent to mobile payment device 200. Mobile device 200 may receive coupons from the issuer, the coupon administering entity, or the payment processing network. In some embodiments, coupon management module 209 can sort and organize the received coupons based on various default and/or consumer-defined criteria. It can communicate with a mobile payment application (MPA) 220 to deliver coupons to user interface 221 for presentation to the consumer. In some embodiments, computer readable storage medium 206 may store instructions or programs that may allow mobile payment device 200 to communicate with the coupon administering entity to receive one or more coupons, enroll in the coupon redemption program or manage the consumer's enrollment status. The instructions or programs may also enable the mobile payment device to interact with the access device at a merchant to conduct a payment transaction using the contactless element, in addition to other functions of a cellular phone.

In some embodiments, mobile payment application 220 can be configured to work in conjunction with contactless element 207 to process payment transactions. Also, mobile payment application 220 may have a user interface 221 associated with it. In some embodiments, a consumer may interact with mobile payment application 220 via user interface 221 to view and redeem coupons and conduct payment transactions. More specifically, user interface 221 may allow the consumer to view a coupon and perform one or more operations with the coupon such as, using the coupon in a transaction. In addition, a consumer may be able to interact with mobile payment application 220 and the coupon management module 209 in order to manage and redeem coupons.

In accordance with certain embodiments, the mobile device may further include a Global Positioning System (GPS) element 203. GPS element 203 may be configured to allow determination of the location of the consumer at any time. In particular, GPS element 203 can rely upon signals from a plurality of orbiting satellites in order to allow the consumer's location to be determined. Location information obtained from GPS element 203 may in turn be communicated through antenna 230 to allow monitoring of the consumer's position.

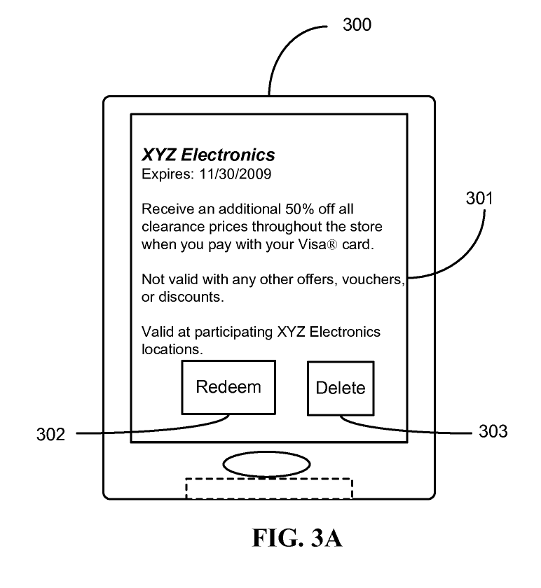

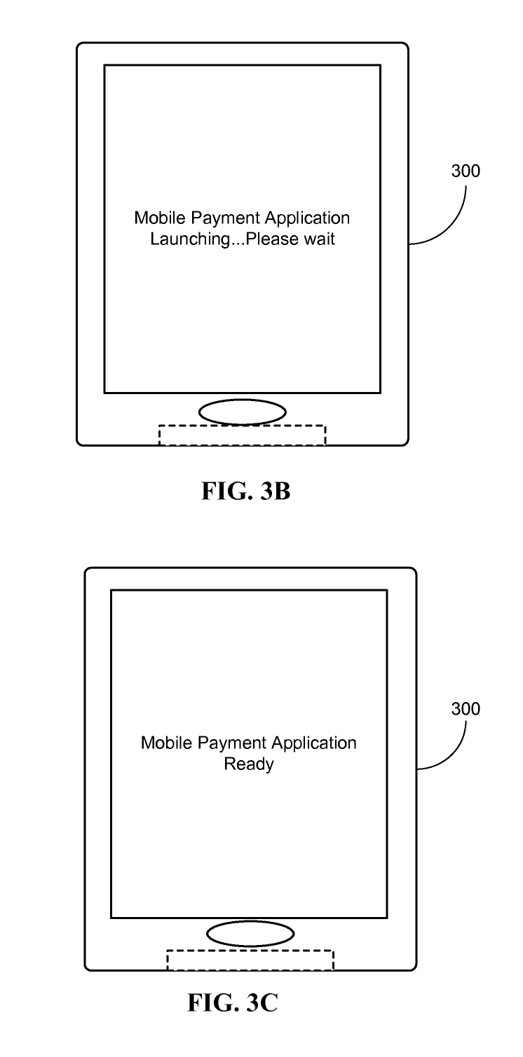

FIG. 3A illustrates a sample coupon that may be displayed on a mobile payment device 300. Mobile payment device 300 may include a display screen 301 that is capable of displaying a coupon, in addition to other information. Display screen may be a standard display or a touch screen display. As illustrated, the coupon may include information about the product or item that is the subject of the coupon. In some embodiments, the coupon may include additional information that may be deemed necessary by the coupon administering entity in order to redeem the coupon. In some embodiments, the consumer may be presented with a choice to redeem the coupon by selecting a redeem button 302 or to delete the coupon by selecting a delete button 303. Both delete button 303 and redeem button 302 may be implemented as selectable icons on a touch screen or as physical buttons on the mobile payment device 300 assigned to perform these functions. If the consumer does not wish to use a particular coupon, he may select delete button 303 and purge the coupon from mobile payment device 300.

Each coupon may include one or more pieces of information referred to as coupon data. Since the coupon is stored in an electronic format, using the coupon may involve transferring the coupon data from the mobile payment device to a receiving terminal, e.g., a POS terminal, at a merchant location. The coupon data may include a unique coupon code that may be configured for one time use only. This is will prevent fraudulent and/or multiple use of the same coupon. The coupon data may further include an expiration date of the coupon, description of an item associated with the coupon, name of the coupon issuer, e.g., coffee shop A, merchant locations where the coupon is valid, and any other restrictions associated with the coupon. During a transaction, some or all of this coupon data may be transferred to the receiving terminal. In some embodiments, once a coupon is used in a transaction, the coupon may be automatically deleted from mobile payment device 300, thus preventing multiple uses of the same coupon.

In some embodiments, a list of consumer-deleted coupons may be sent back to the coupon administering entity, which may determine a preference of coupon usage for a particular consumer based on that information. For example, if a consumer consistently deletes coupons related to home improvement stores, then the coupon administering entity may conclude that the consumer is not interested in coupons for home improvement stores and the coupon administering entity may discontinue sending coupons related to home improvement stores to the consumer. This is will greatly enhance consumer satisfaction by focusing the coupon delivery to be based on consumer purchase pattern. This will also greatly reduce the time spent in sending coupons that will potentially never be used thus making the coupon administering process more efficient. In some embodiments, the consumer may contact the coupon administering entity, e.g., via a website, and set his preferences on the type and amount of coupons he may wish to receive. For example, the consumer may specify that he only wishes to receive coupons related to consumer electronic items. In addition, the consumer may also specify that he would like to receive no more than 10 coupons per month. The coupon administering entity can store this information for each consumer and customize coupon delivery based on the indicated preferences.

In some embodiments, the payment processing network may gather transaction data for a particular consumer for transactions performed using the mobile payment device. The transaction information may be sent to the coupon administering entity. The coupon administering entity may analyze the transaction information to determine the consumer's spending habits and purchasing trends. Based on the spending habits and purchasing trends, the coupon administering entity may determine the type and amount of coupons to send to the consumer's mobile device. For example, if the analysis of transaction information for a consumer indicates that the consumer frequently shops at a particular home improvement store, the coupon administering entity may send coupons for that particular home improvement, its competitor, or coupons for items related to the items that the consumer has already purchased. Thus, the coupon administering can customize the coupon delivery based on products or services, merchants, or any other criteria that may be tracked using the transaction information.

If the consumer selects redeem button 302, mobile payment device 300 may automatically initiate the mobile payment application. FIGS. 3B and 3C illustrate sample screens that the consumer may be presented with as the mobile payment application is being activated. Once activated, the mobile payment application can be used to conduct a transaction using the selected coupon. In some embodiments, the mobile payment application may be configured to be in a deactivated state as a default. In such instances, selecting redeem button 302 may temporarily override the default configuration of the mobile payment application and the mobile payment application may be automatically initiated. Once the transaction is complete, the mobile payment application may be returned back to its default deactivated state.

In some embodiments, automatically initiating the mobile payment application may include, launching the mobile payment application, by the mobile payment device, when it received an input indicating the consumer's desire to use a coupon. In location based coupon delivery process, where a coupon is delivered to the mobile payment device based on the location of the mobile payment device (and thus the consumer), automatically initiating the mobile payment application may include activating the mobile payment application immediately upon receipt of a coupon related to the location of the mobile payment device. For example, if a consumer is at a coffee shop, the GPS device in the mobile payment device may be queried to ascertain the location of the mobile payment device. The coupon administering entity, the issuer, the aggregator, or the payment processing network may send a coupon that can be redeemed at the coffee shop associated with the location information received from the GPS device of the mobile payment device. Upon receiving the coupon, mobile payment device may automatically initiate the mobile payment application providing the consumer the opportunity to use the coupon.

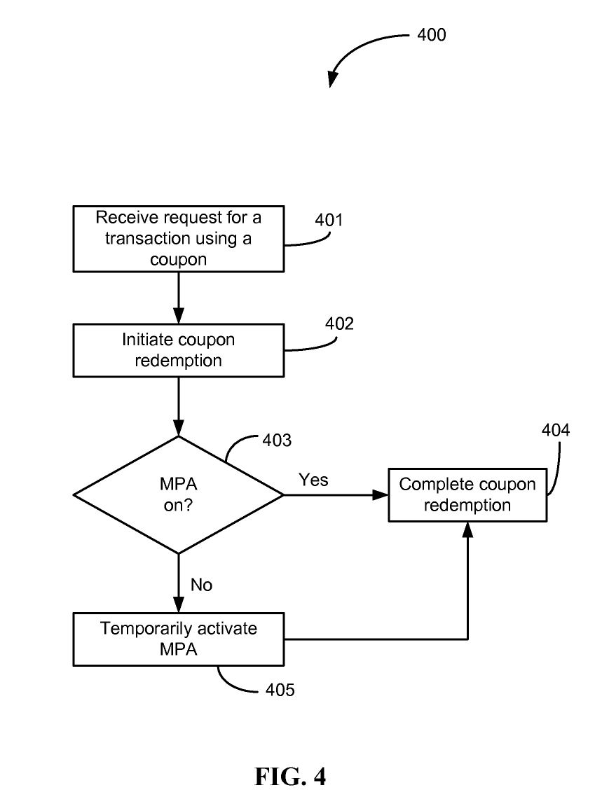

FIG. 4 shows a flow diagram of a process 400 for using a coupon according to an embodiment of the present invention. At step 401, the mobile payment device receives a request to conduct a transaction using a coupon. In some embodiments, the consumer may select a particular coupon and select the redeem button, described above, to initiate a transaction. In other embodiments, depending on the configuration of the mobile payment device, a coupon may be selected automatically based on the merchant information, item information, or other identifying information that may be gathered from the transaction details. For example, the mobile payment device can determine, based on the transaction information, whether there is coupon that can be used for that particular transaction. At step 402, the mobile payment device may initiate coupon redemption process. At step 403, the mobile payment device may check to determine whether the mobile payment application is operational. In this instance, “operational” means that the mobile payment application is currently active and ready to conduct a transaction. If it is determined that the mobile payment application is active, the transaction may be completed using the coupon at step 404. If it is determined that the mobile payment application is not currently active, the mobile payment device may automatically initiate the mobile payment application for that particular transaction at step 405 and complete the transaction using the coupon at step 404. As part of completing the transaction, the mobile payment device may transfer the coupon data associated with the coupon to a receiving terminal (e.g., the access device 101 of FIG. 1) at the merchant location where the coupon is to be redeemed. In some embodiments, the mobile payment device may deactivate the mobile payment application after the transaction is completed, e.g., by closing the mobile payment application.

“Using” a coupon, as described above, may include transferring coupon data, e.g., a coupon code, to a POS terminal (implementing the access device 101 of FIG. 1) at merchant using the contactless element of the mobile payment device. The POS terminal may communicate the coupon data to the coupon administering entity, e.g., via the payment processing network. The coupon administering entity may validate the coupon data and the mobile payment device and upon validation send an coupon acceptance message to the POS terminal. In some embodiments, the POS terminal may display the acceptance message on a display coupled to the POS terminal or indicate acceptance of the coupon on a printed receipt accompanying the transaction.

It will be appreciated that process 400 described herein is illustrative and that variations and modifications are possible. Acts described as sequential can be executed in parallel, order of acts can be varied, and acts can be modified or combined. For instance, at step 402, the mobile payment device may initiate coupon redemption and automatically activate the mobile payment application without determining whether the mobile payment application is active or inactive.

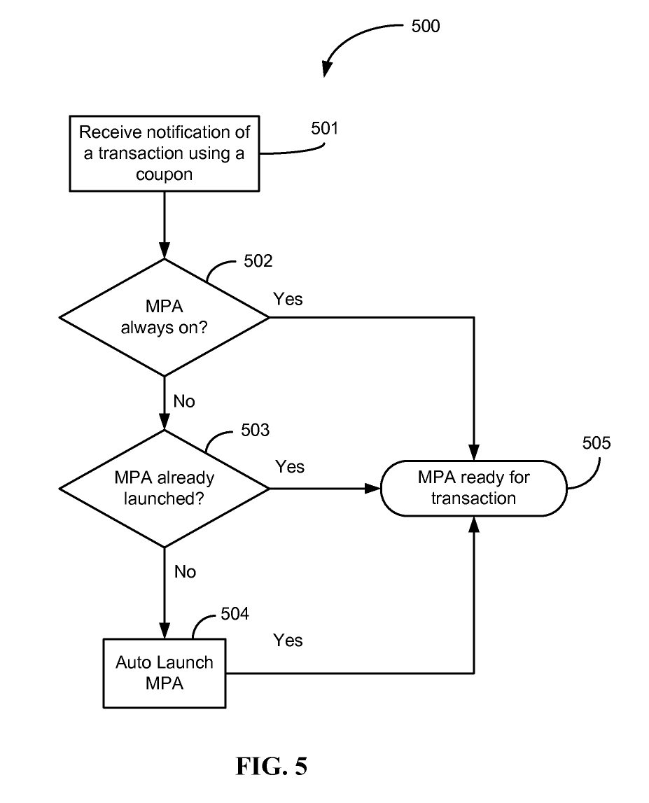

FIG. 5 shows a flow diagram of a process 500 for using a coupon according to an embodiment of the present invention. At step 501, the mobile payment device receives an indication that the consumer wishes to conduct a transaction that includes use of a coupon, e.g., when the consumer selects the redeem button on the mobile payment device. At step 502, the mobile payment device can check whether the mobile payment application is configured to be “always on”. If the mobile payment application is configured to be “always on”, the mobile payment application is deemed to be always active and ready to conduct a transaction. If it is determined that the mobile payment application is configured to be “always on”, the mobile payment application is ready to conduct the transaction using the coupon at step 505. If it is determined that the mobile payment application is not configured to be “always on,” the mobile payment device can check whether the mobile payment application has been activated at step 503, e.g., by the consumer manually activating the mobile payment application. If it is determined that the mobile payment application has been activated, the mobile payment application is ready for conducting the transaction using the coupon at step 505.

If it is determined that the mobile payment application has not been activated, the mobile payment device can automatically initiate the mobile payment application at step 504. In some embodiments, when the mobile payment device determines that the mobile payment application is not active at step 503, the mobile payment device can automatically start the mobile payment application resident on the mobile payment device and place the mobile payment application in a state where it is ready to conduct a transaction. Once the mobile payment application is activated, the mobile payment application is now ready to conduct a transaction at step 505. For example, the transaction may include purchasing the item identified in the coupon.

It will be appreciated that process 500 described herein is illustrative and that variations and modifications are possible. Acts described as sequential can be executed in parallel, order of acts can be varied, and acts can be modified or combined. For instance, step 502 can be omitted and the mobile payment device can verify whether the mobile payment application is activated immediately after receiving an indication for conducting a transaction.

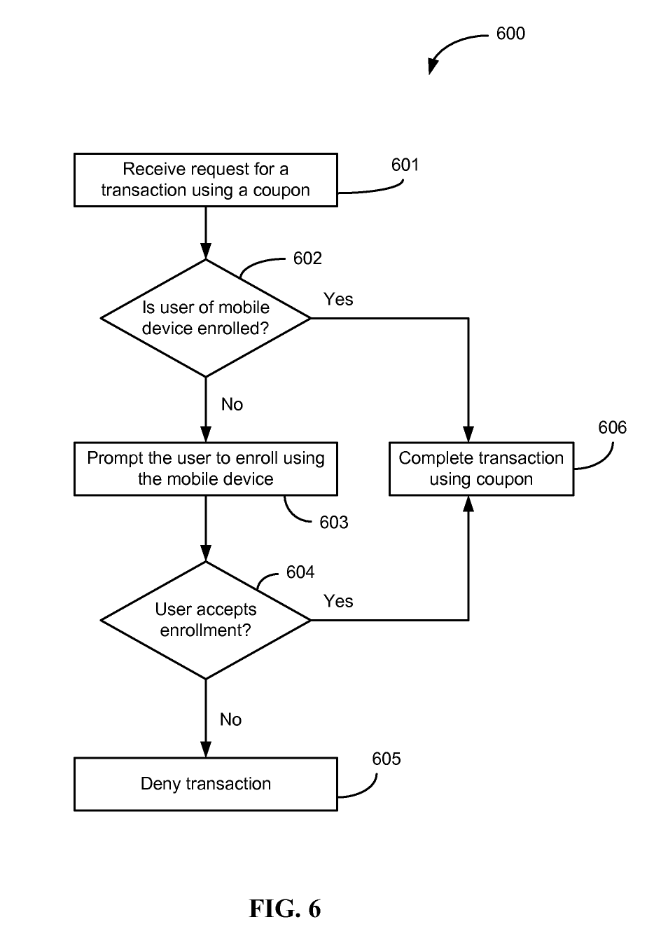

FIG. 6 shows a flow diagram of a process 600 for using a coupon according to another embodiment of the present invention. In this embodiment, a coupon administering entity can receive a request from the mobile payment device of a consumer requesting redemption of a coupon at step 601. At step 602, the coupon administering entity can verify whether the consumer's mobile payment device is enrolled in a coupon redemption program and whether the consumer is authorized to use the particular coupon for that transaction. In some embodiments, the coupon administering entity may require that the consumer be enrolled in a coupon redemption program prior to receiving coupons on this mobile payment device. In addition, the coupon administering entity may also require the consumer to enroll in the coupon redemption program in order to redeem those coupons using his mobile payment device and the mobile payment application resident on the mobile payment device. In some embodiments, the coupon administering entity may offer to enroll the consumer in the coupon redemption program as part of the coupon redemption transaction. If it is determined that the consumer's mobile payment device is enrolled in the coupon redemption program, the transaction using the coupon is allowed to proceed at step 606. If it is determined that the consumer's mobile payment device is not enrolled in the coupon redemption program, the coupon administering entity may send a message to the consumer's mobile payment device requesting the consumer to enroll in the coupon redemption program at step 603. For example, the request may be in form of a message informing the consumer to obtain authorization from the coupon administering entity for using the coupon. In some embodiments, the message may be displayed on the mobile payment device and the consumer may be prompted to either request the authorization or continue the transaction without using the coupon.

In some embodiments, the consumer may either agree to send the authorization request or decide to not use the coupon. At step 604, the coupon administering entity may determine whether the consumer has accepted or declined to enroll in the coupon redemption program based on the input received from the mobile payment device. In some embodiments, the authorization request may include a request to enroll in the coupon redemption program. If the authorization request indicates that the consumer has requested to enroll in the coupon redemption program, the consumer's mobile payment device is enrolled in the coupon redemption program. In some embodiments, the coupon administering entity may send a response to the mobile payment device indicating the consumer's enrollment status in the coupon redemption program. Once the mobile payment device receives a response indicating successful enrollment in the coupon redemption program from the coupon administering entity, the mobile payment device can conduct the transaction using the coupon at step 606.

In some embodiments, step 602 may include the coupon administering entity determining whether the consumer is authorized to conduct the transaction using the coupon. In this instance, the mobile device may communicate with the coupon administering entity to determine the enrollment status of the consumer in the coupon redemption program. The coupon administering entity may send information regarding the consumer's enrollment status to the mobile device. Once the information about enrollment status is received by the mobile communication device, the consumer may either be prompted to enroll in the coupon redemption program if he is not already enrolled or the transaction may be allowed if the consumer is already enrolled.

On the other hand, if the coupon administering entity determines that the consumer has declined to enroll in the coupon redemption program at step 604, the coupon administering entity may decline the use of the coupon for that transaction at step 605. It is to be noted that the consumer may still complete the transaction without using the coupon if he chooses to do so.

It will be appreciated that process 600 described herein is illustrative and that variations and modifications are possible. Acts described as sequential can be executed in parallel, order of acts can be varied, and acts can be modified or combined.

In some embodiments, a consumer may be provided with a coupon, however, to use the coupon, the consumer may be asked to enroll in a coupon redemption program. This will ensure that the consumer is interested in using the coupon. In addition, by making the effort to enroll in a coupon redemption program, the consumer indicates his willingness and desire to receive and use more coupons. The extra step of enrollment may serve to eliminate the consumers who may not want to expend any effort in receiving coupons or use coupons and who would have paid an undiscounted price for the item if they did not have the coupon. The coupon issuers may not want such consumers to benefit from the coupons. In some embodiments, the coupon administering entity can monitor such behavior by consumers to track the number of consumers that enroll in the coupon redemption program. In addition, the coupon administering entity can also track consumers who do not used coupons. The coupon administering entity can then stop sending coupons to the consumers who do not use the coupons.

In some embodiments, upon selecting the redeem button on the mobile payment device, the mobile device may automatically send a message to the coupon administering entity requesting enrollment in the coupon redemption program. In some embodiments, the consumer may be concurrently notified via the mobile payment device the requirement of enrolling in the coupon redemption program prior to using the coupon. Thereupon, the consumer may be given a choice to enroll in the coupon redemption program without having to conduct a separate transaction for enrolling in the program. For example, the consumer may be presented with a message indicating requirement for enrollment in order to redeem the coupon and providing options to either accept or decline. If the consumer accepts, his mobile payment device may be enrolled in the program concurrent to the transaction being processed using that coupon. Thus, the consumer need not have to enroll in the coupon redemption program prior to using a coupon for the first time. If the consumer declines, he may still conduct his transaction but he may not use the coupon for that transaction.

In some embodiments, when the mobile payment device sends a request for enrollment in the coupon redemption program to the coupon administering entity, the coupon administering entity may determine whether the consumer is eligible to be enrolled in the coupon redemption program. The eligibility check may include checking the customer's creditworthiness, his purchasing and chargeback history, etc. Based on the determination, the coupon administering entity may either allow or deny enrollment. In the instance where the coupon administering entity denies enrollment, the consumer may be notified accordingly, e.g., via a message on his mobile payment device. It is to be noted that a request for enrollment in the coupon redemption program does not guarantee acceptance unless a minimum threshold is met. The issuer or the coupon administering entity in conjunction with the coupon issuer may set the threshold.

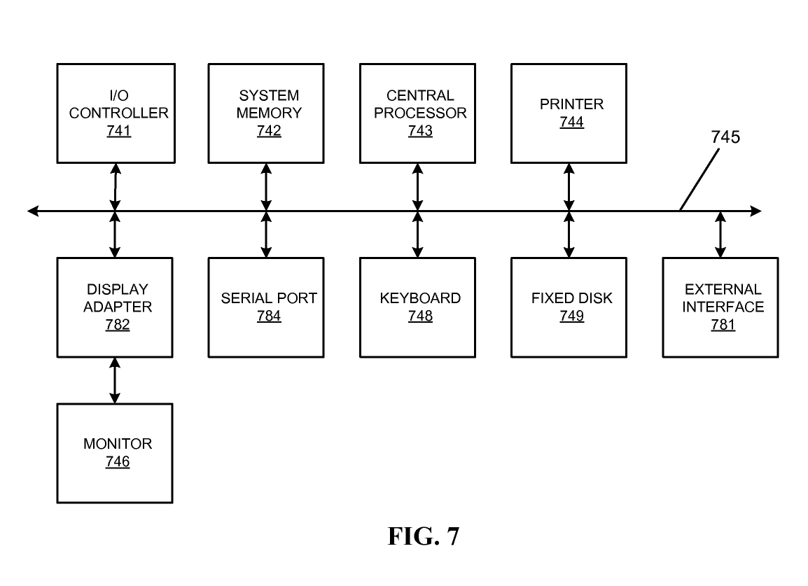

Any of the server computers, client computers, and even some mobile payment devices described above may utilize any suitable number of subsystems. Examples of such subsystems or components are shown in FIG. 7, which is a block diagram of a computer apparatus. The subsystems shown in FIG. 7 are interconnected via a system bus 775. Additional subsystems such as a printer 774, keyboard 778, fixed disk 779, monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Many advantages are realized by the various embodiments described above. Sending the coupons to the mobile device increases the likelihood that the coupons will be actually used unlike in the conventional method where many of the coupons go unused due the effort involved in managing and using the coupons. A coupon issuer can easily target his coupons towards most likely consumers of the coupon since the coupon issuer can now gather data about spending habits of consumers based on realtime transaction data. Targeting the coupons to the appropriate consumers may increase the probability that the intended products or services are actually bought by the consumer. From the consumer end, the consumer can customize the amount and type of coupons he wants to receive. Having this ability will likely result in the increased used of coupons by the consumer. Another advantage of an automated coupon system, as described above, is that it greatly simplifies the coupon administration procedure thereby making the entire coupon redemption process easy to administer and use. In particular, a consumer need not look at and take the time to manually launch multiple applications and coupons, thus making it more likely that the consumer will use a particular coupon and payment application. This not only benefits the consumer, but it also benefits merchants, issuers, and other entities.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method comprising:
receiving coupon data at a mobile device, wherein the mobile device comprises a mobile payment application;
determining, by the mobile device, if the mobile payment application is operational;
automatically initiating the mobile payment application, by the mobile device, after the coupon data is received by the mobile device; and
transferring the coupon data, by the mobile device, to a receiving terminal as part of a transaction.

2. The method of claim 1 further comprising receiving, by the mobile device, the coupon data from a coupon administering entity.

3. The method of claim 1 wherein automatically initiating the mobile payment application includes automatically starting the mobile payment application upon receiving the coupon data.

4. The method of claim 1 wherein the transaction includes purchasing an item identified in the coupon data.

5. The method of claim 1 further comprising deactivating the payment application upon completion of the transaction.

6. The method of claim 1 further comprising enrolling in a coupon redemption program prior to transferring the coupon data.

7. The method of claim 1 further comprising, prior to transferring the coupon data:
determining whether a user of the mobile payment application is authorized to transfer the coupon data;
if it is determined that the user is not authorized to transfer the coupon data, requesting the user to obtain authorization from a coupon data administering entity;
sending an authorization request to the coupon data administering entity based on the user response to the request; and
receiving authorization from the coupon data administering entity to transfer the coupon data.

8. The method of claim 7 wherein determining whether the user is authorized includes:
communicating with the coupon data administering entity to request information about whether the user is enrolled in a coupon redemption program; and
receiving information from the coupon data administering entity about the user's enrollment status.

9. The method of claim 7 wherein sending an authorization request to the coupon administering entity includes a request for enrolling in a coupon redemption program.

10. A computer-readable storage medium storing instructions, which when executed by a controller in a mobile communication device, causes the controller to perform a method of claim 1.

11. A computer-implemented method for managing a coupon redemption program, by a coupon administering entity, the method comprising:
receiving a request, from a user mobile device, for enrolling the user mobile device in the coupon redemption program;
enrolling the user mobile device in the coupon redemption program; and
sending a coupon to the user mobile device.

12. The method of claim 11 further comprising:
tracking transaction information for one or more transactions performed using the user mobile device; and
sending the coupon to the user mobile device based at least in part on the transaction information for the one or more transactions.

13. The method of claim 11 further comprising:
receiving information about one or more deleted coupons from the user mobile device;
analyzing the information about the one or more deleted coupons; and
sending the coupon to the user mobile device based at least in part on the analysis of the deleted coupons.

14. The method of claim 13 wherein sending the coupon based on the analysis of the deleted coupons includes excluding a coupon that is similar to the deleted coupons.

15. The method of claim 11 further comprising checking whether the mobile device is enrolled in a coupon redemption program prior to enrolling the mobile device.

16. A mobile payment device comprising:
a mobile payment application configured to enable a user to perform transactions using the mobile payment device;
a coupon management module configured to receive coupon data from a coupon administering entity;
a processor coupled to the mobile payment application and the coupon management module and configured to:
retrieve coupon data from the coupon management module;
determine whether the mobile payment application is operational;
automatically initiate the mobile payment application after retrieving the coupon data; and
transfer the coupon data to a receiving terminal as part of a transaction.

17. The mobile payment device of claim 16 wherein the processor is further configured to communicate with an external server for enrolling into a coupon redemption program.

18. The mobile payment device of claim 16 further including a user interface configured to display the coupon data and receive inputs associated with management of the coupon data.

19. The mobile payment device of claim 16 wherein the processor is further configured to communicate information about deleted coupon data to an external coupon administering entity.
